(19) United States
(12) Patent Application Publication
(10) Pub. No.: US 2026/0246592 A1
(43) Pub. Date: Aug. 20, 2026

(54) COMMUNICATION METHOD AND DEVICE USING MULTIPLE TRANSMISSION AND RECEPTION POINTS IN COMMUNICATION SYSTEM

(71) Applicants: HYUNDAI MOTOR COMPANY, Seoul (KR); Kia Corporation, Seoul (KR)

(72) Inventor: Jeong Su Lee, Hwaseong-si, Gyeonggi-do (KR)

(73) Assignee: Kia Corporation, Seoul (KR)

(21) Appl. No.: 19/144,872

(22) PCT Filed: Feb. 19, 2024
(86) PCT No.: PCT/KR2024/095412

§ 371 Date: Jun. 30, 2025

(30) Foreign Application Priority Data
Feb. 17, 2023 (KR) 10-2023-0021677

(51) Int. Cl. H04L 5/00; H04B 7/06

(52) U.S. Cl. CPC H04L 5/0053; H04B 7/0695

(57) ABSTRACT

A method of a UE, according to an embodiment of the present disclosure, may comprise the steps of: using a first beam to perform communication on the basis of a first TRP and a state type of a configured TCI; receiving a TCI state change indication of the first TRP; configuring, on the basis of the received TCI state change indication, a second beam for communicating with the first TRP during a BAT; and using the second beam so as to perform uplink (UL) transmission of the first information if the UL transmission of the first information to the first TRP is necessary.

### TECHNICAL FIELD

The present disclosure relates to an enhanced communication technique, and more particularly, to a communication technique using multiple transmission and reception points.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FRI) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, the 5G NR technical specifications, established by the standardization body 3GPP, allow physical channels to be used either separately by each transmission and reception point (TRP) or panel, or to be shared among multiple TRPs or panels, in order to ensure downlink reliability and improve transmission rates in cell-edge areas of wireless communication systems. Wireless communication schemes employing such techniques may target representative use cases such as URLLC and eMBB. In the 3GPP Rel-17 standardization, technical discussions and standardization efforts were conducted regarding enhancements to the physical downlink control channel (PDCCH) to support multi-TRP (mTRP) environments. In 5G NR, methods for ensuring PDCCH reliability in mTRP environments may be implemented differently depending on deployment scenarios. These scenarios may be broadly classified into two types: single-frequency network (SFN) schemes and non-SFN schemes.

In 3GPP Rel-18 standardization, it was decided that a unified transmission configuration indicator (TCI) framework, originally designed in Rel-17 for single TRP (sTRP) scenarios, would be adopted for use in mTRP systems.

Accordingly, a detailed discussion is now required regarding how the unified TCI framework, originally developed for sTRP scenarios, can be applied to mTRP scenarios. Furthermore, on the user equipment (UE) side, time is required to configure a beam when updating a TCI state that is indicated and/or configured. This beam configuration time may be defined by a beam application time (BAT). Since a duration according to the BAT was defined by the 3GPP for sTRP scenarios, potential issues that may arise when extending its application to mTRP scenarios, along with corresponding solutions, should be addressed.

### DISCLOSURE

### Technical Problem

The present disclosure is directed to providing a method and an apparatus for applying a beam application time (BAT) in a multi-TRP (mTRP) environment.

### Technical Solution

A method of a user equipment (UE), according to exemplary embodiments of the present disclosure for achieving the above-described objective, may comprise: communicating with a first transmission and reception point (TRP) using a first beam based on a transmission configuration indicator (TCI) state type configured for the first TRP; receiving a TCI state change indication for the first TRP; configuring, during a time duration defined by a beam application time (BAT), a second beam for communicating with the first TRP based on the received TCI state change indication; and in response to transmission of first information in uplink (UL) being required, transmitting the first information to the first TRP in the uplink using the second beam,
wherein a time for transmitting the first information in the UL is determined as a time after a sum of a first time based on a processing capability of the UE and the BAT.

The first time may be determined as a sum of a margin value and a first processing time for a physical downlink shared channel (PDSCH) received from the first TRP, the first processing time being expressed as a number of symbols according to the processing capability of the UE.

The method may further comprise: receiving first indication information indicating whether to allow UL transmission for the first TRP within the time duration defined by the BAT; and in response to the first indication information indicating that the UL transmission is allowed and presence of second information to be transmitted within the time duration defined by the BAT, transmitting the second information to the first TRP using the first beam within the time duration defined by the BAT.

The time for transmitting the first information may be determined as a time after the first time.

The method may further comprise: receiving second indication information indicating whether to allow downlink (DL) reception from the first TRP within the time duration defined by the BAT; and in response to the second indication information indicating that the DL reception is not allowed, stopping a DL reception operation within the time duration defined by the BAT.

The method may further comprise: receiving second indication information indicating whether to allow DL reception from the first TRP within the time duration defined by the BAT; and in response to the second indication information indicating that the DL reception is allowed and presence of third information scheduled to be received within the time duration defined by the BAT, receiving the third information from the first TRP using the first beam within the time duration defined by the BAT.

A user equipment (UE), according to exemplary embodiments of the present disclosure for achieving the above-described objective, may comprise: at least one processor, wherein the at least one processor may cause the UE to perform:
communicating with a first transmission and reception point (TRP) using a first beam based on a transmission configuration indicator (TCI) state type configured for the first TRP; receiving a TCI state change indication for the first TRP; configuring, during a time duration defined by a beam application time (BAT), a second beam for communicating with the first TRP based on the received TCI state change indication; and in response to transmission of first information in uplink (UL) being required, transmitting the first information to the first TRP in the uplink using the second beam,
wherein a time for transmitting the first information in the UL is determined as a time after a sum of a first time based on a processing capability of the UE and the BAT.

The first time may be determined as a sum of a margin value and a first processing time for a physical downlink shared channel (PDSCH) received from the first TRP, the first processing time being expressed as a number of symbols according to the processing capability of the UE.

The at least one processor may further cause the UE to perform:
receiving first indication information indicating whether to allow UL transmission for the first TRP within the time duration defined by the BAT; and in response to the first indication information indicating that the UL transmission is allowed and presence of second information to be transmitted within the time duration defined by the BAT, transmitting the second information to the first TRP using the first beam within the time duration defined by the BAT.

The time for transmitting the first information may be determined as a time after the first time.

The at least one processor may further cause the UE to perform:
receiving second indication information indicating whether to allow downlink (DL) reception from the first TRP within the time duration defined by the BAT; and in response to the second indication information indicating that the DL reception is not allowed, stopping a DL reception operation within the time duration defined by the BAT.

The at least one processor may further cause the UE to perform:
receiving second indication information indicating whether to allow DL reception from the first TRP within the time duration defined by the BAT; and in response to the second indication information indicating that the DL reception is allowed and presence of third information scheduled to be received within the time duration defined by the BAT, receiving the third information from the first TRP using the first beam within the time duration defined by the BAT.

A method of a base station, according to exemplary embodiments of the present disclosure for achieving the above-described objective, may comprise: determining a transmission configuration indicator (TCI) state type of each of transmission and reception points (TRPs) connected to the base station; transmitting, to the TRPs, information on TCI state types of the TRPs; in response to a change in a TCI state type of a first TRP among the TRPs being required, transmitting TCI state type update information to the first TRP; determining a transmission scheme of an uplink (UL) channel or a downlink (DL) channel within a first time duration that at least partially overlaps with a time duration defined by a beam application time (BAT) of a user equipment (UE) communicating with the first TRP; and transmitting information on the transmission scheme of the UL channel or the DL channel to the first TRP and the UE.

The information on the TCI state types may be configured by individually mapping information capable of identifying each of the TRPs and a corresponding TCI state type.

The information capable of identifying each of the TRPs may include at least one of a TRP identifier (ID), a control resource set (CORESET) identifier (ID), a CORESET group ID, or a search space ID.

The TCI state types may be respectively configured for preconfigured TRP groups, and information on the TRP groups may be transmitted to the TRPs through higher layer signaling.

When a change in the TCI state type of the first TRP among the TRPs is required and a change in a TCI state type of a second TRP belonging to a same TRP group as the first TRP is required, transmission of information indicating an update of the TCI state type of the second TRP may be omitted.

The information on the TCI state types may be configured by concatenating one-bit values respectively indicating TCI state types of the TRPs, based on a descending or ascending order of TRP indexes corresponding to the TRPs.

The transmission scheme of the UL channel or the DL channel within the first time duration may be configured based on a TCI state type before a TCI state update.

The transmission scheme may be configured to prohibit transmission of the UL channel or the DL channel within the first time duration, and the transmission scheme may be determined based on UE capability information reported in advance from the UE.

### Advantageous Effects

According to the present disclosure, an advantage is that a TCI state update can be performed per TRP for a unified TCI state. In addition, by using a common TCI state pool (or a common TCI state list), signaling overhead can be reduced. TCI state updates can also be applied to multiple TRPs simultaneously. Furthermore, when a physical channel and a duration defined by a BAT partially or fully overlap, it is possible to determine whether to transmit and/or receive the physical channel. In such a case, it is also possible to determine whether to transmit or receive the physical channel based on a TCI state prior to a change to an indicated TCI state, depending on a capability of the UE. Accordingly, ambiguity in the transmission and/or reception of the physical channel overlapping with the duration defined by the BAT can be resolved, while improving channel utilization.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of communication nodes performing communication.

FIG. 4A is a block diagram illustrating a first exemplary embodiment of a transmission path.

FIG. 4B is a block diagram illustrating a first exemplary embodiment of a reception path.

FIG. 5 is a conceptual diagram illustrating a first exemplary embodiment of a system frame in a communication system.

FIG. 6 is a conceptual diagram illustrating a first exemplary embodiment of a subframe in a communication system.

FIG. 7 is a conceptual diagram illustrating a first exemplary embodiment of a slot in a communication system.

FIG. 8 is a conceptual diagram illustrating a first exemplary embodiment of a time-frequency resource in a communication system.

FIG. 9 is a conceptual diagram illustrating a scenario in which a TCI state pool is extended from a single TRP to multiple TRPs.

FIG. TOA is a conceptual diagram illustrating a case where the same TCI state type is configured for two TRPs.

FIG. 10B is a conceptual diagram illustrating a case where different TCI state types are respectively configured for two TRPs.

FIG. 11 is a conceptual diagram illustrating a case where a TCI state change of one TRP is indicated in an environment where multiple TRPs communicate with a UE.

FIG. 12A is a partial sequence chart illustrating a case where the second exemplary embodiment is applied after the first exemplary embodiment according to the present disclosure.

FIG. 12B is a remaining sequence chart illustrating the case where the second exemplary embodiment is applied after the first exemplary embodiment according to the present disclosure.

### BEST MODE OF THE INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

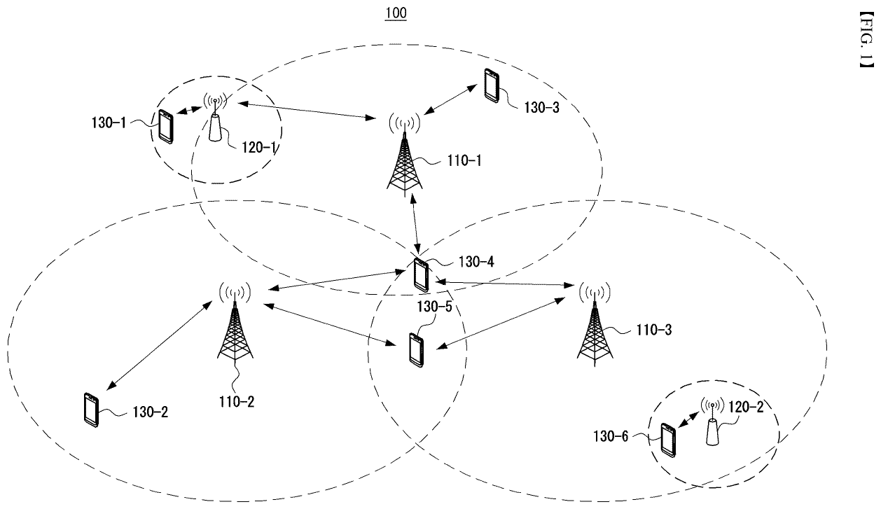

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g. a serving gateway (S-GW), a packet data network (PDN) gateway (P-GW), a mobility management entity (MME). When the communication system 100 is a 5G communication (e.g. NR system), the core network may include an access and mobility management function (AMF), a user plane function (UPF), a session management function (SMF), and the like.

The plurality of communication nodes 110 to 130 may support communication protocols (e.g. LTE communication protocol, LTE-A communication protocol, NR communication protocol, etc.) specified in 3^{rd} generation partnership project (3GPP) standards. The plurality of communication nodes 110 to 130 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

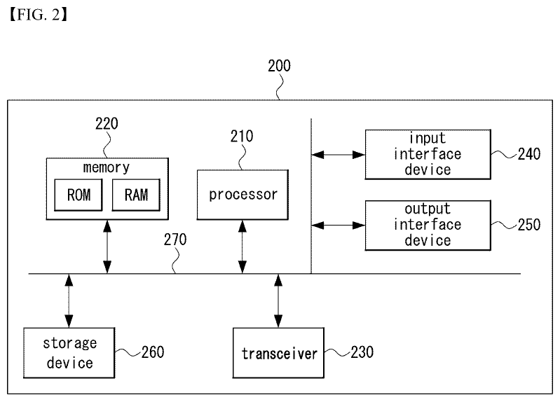

FIG. 2 is a block diagram illustrating a first exemplary embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, sidelink communication (e.g. device-to-device (D2D) communication, proximity services (ProSe)), Internet of Things (IoT) communication, dual connectivity (DC), and/or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control sidelink communications between the fourth terminal 130-4 and the fifth terminal 130-5, and thus the fourth terminal 130-4 and the fifth terminal 130-5 may perform the sidelink communications under control of the second base station 110-2 and the third base station 110-3, respectively.

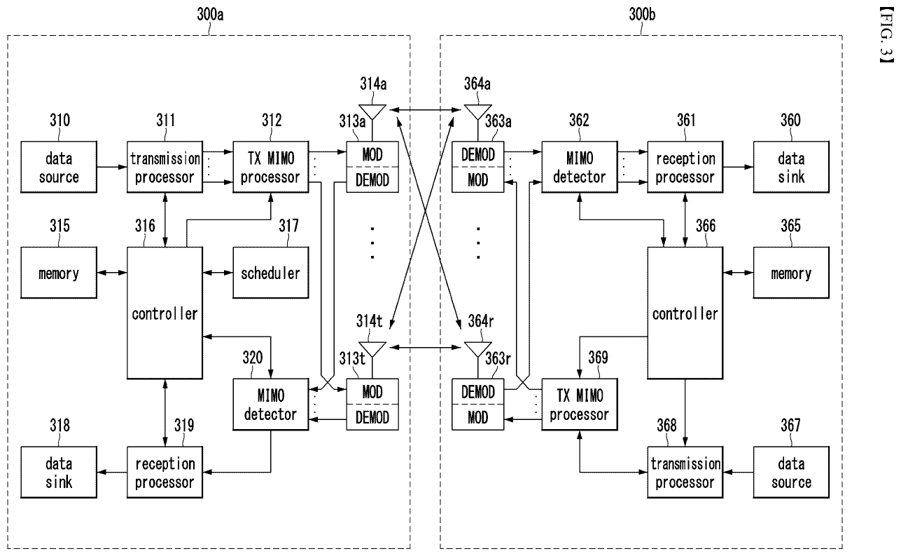

Meanwhile, communication nodes that perform communications in the communication network may be configured as follows. A communication node shown in FIG. 3 may be a specific exemplary embodiment of the communication node shown in FIG. 2.

FIG. 3 is a block diagram illustrating a first exemplary embodiment of communication nodes performing communication.

As shown in FIG. 3, each of a first communication node 300a and a second communication node 300b may be a base station or UE. The first communication node 300a may transmit a signal to the second communication node 300b. A transmission processor 311 included in the first communication node 300a may receive data (e.g. data unit) from a data source 310. The transmission processor 311 may receive control information from a controller 316. The control information may include at least one of system information, RRC configuration information (e.g. information configured by RRC signaling), MAC control information (e.g. MAC CE), or PHY control information (e.g. DCI, SCI).

The transmission processor 311 may generate data symbol(s) by performing processing operations (e.g. encoding operation, symbol mapping operation, etc.) on the data. The transmission processor 311 may generate control symbol(s) by performing processing operations (e.g. encoding operation, symbol mapping operation, etc.) on the control information. In addition, the transmission processor 311 may generate synchronization/reference symbol(s) for synchronization signals and/or reference signals.

A Tx MIMO processor 312 may perform spatial processing operations (e.g. precoding operations) on the data symbol(s), control symbol(s), and/or synchronization/reference symbol(s). An output (e.g. symbol stream) of the Tx MIMO processor 312 may be provided to modulators (MODs) included in transceivers 313a to 313t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 313a to 313t may be transmitted through antennas 314a to 314t.

The signals transmitted by the first communication node 300a may be received at antennas 364a to 364r of the second communication node 300b. The signals received at the antennas 364a to 364r may be provided to demodulators (DEMODs) included in transceivers 363a to 363r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 362 may perform MIMO detection operations on the symbols. A reception processor 361 may perform processing operations (e.g. de-interleaving operation, decoding operation, etc.) on the symbols. An output of the reception processor 361 may be provided to a data sink 360 and a controller 366. For example, the data may be provided to the data sink 360 and the control information may be provided to the controller 366.

On the other hand, the second communication node 300b may transmit signals to the first communication node 300a. A transmission processor 368 included in the second communication node 300b may receive data (e.g. data unit) from a data source 367 and perform processing operations on the data to generate data symbol(s). The transmission processor 368 may receive control information from the controller 366 and perform processing operations on the control information to generate control symbol(s). In addition, the transmission processor 368 may generate reference symbol(s) by performing processing operations on reference signals.

A Tx MIMO processor 369 may perform spatial processing operations (e.g. precoding operations) on the data symbol(s), control symbol(s), and/or reference symbol(s). An output (e.g. symbol stream) of the Tx MIMO processor 369 may be provided to modulators (MODs) included in the transceivers 363a to 363t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 363a to 363t may be transmitted through the antennas 364a to 364t.

The signals transmitted by the second communication node 300b may be received at the antennas 314a to 314r of the first communication node 300a. The signals received at the antennas 314a to 314r may be provided to demodulators (DEMODs) included in the transceivers 313a to 313r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 320 may perform a MIMO detection operation on the symbols. The reception processor 319 may perform processing operations (e.g. de-interleaving operation, decoding operation, etc.) on the symbols. An output of the reception processor 319 may be provided to a data sink 318 and the controller 316. For example, the data may be provided to the data sink 318 and the control information may be provided to the controller 316.

Memories 315 and 365 may store the data, control information, and/or program codes. A scheduler 317 may perform scheduling operations for communication. The processors 311, 312, 319, 361, 368, and 369 and the controllers 316 and 366 shown in FIG. 3 may be the processor 210 shown in FIG. 2, and may be used to perform methods described in the present disclosure.

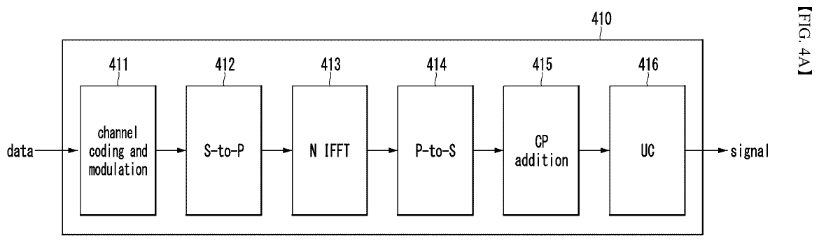

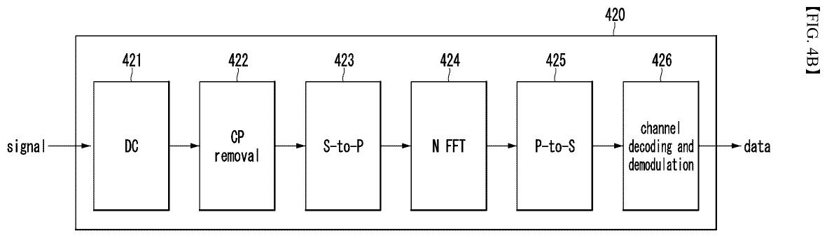

FIG. 4A is a block diagram illustrating a first exemplary embodiment of a transmission path, and FIG. 4B is a block diagram illustrating a first exemplary embodiment of a reception path.

As shown in FIGS. 4A and 4B, a transmission path 410 may be implemented in a communication node that transmits signals, and a reception path 420 may be implemented in a communication node that receives signals. The transmission path 410 may include a channel coding and modulation block 411, a serial-to-parallel (S-to-P) block 412, an N-point inverse fast Fourier transform (N-point IFFT) block 413, a parallel-to-serial (P-to-S) block 414, a cyclic prefix (CP) addition block 415, and up-converter (UC) 416. The reception path 420 may include a down-converter (DC) 421, a CP removal block 422, an S-to-P block 423, an N-point FFT block 424, a P-to-S block 425, and a channel decoding and demodulation block 426. Here, N may be a natural number.

In the transmission path 410, information bits may be input to the channel coding and modulation block 411. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 411 may be a sequence of modulation symbols.

The S-to-P block 412 may convert frequency domain modulation symbols into parallel symbol streams to generate N parallel symbol streams. N may be the IFFT size or the FFT size. The N-point IFFT block 413 may generate time domain signals by performing an IFFT operation on the N parallel symbol streams. The P-to-S block 414 may convert the output (e.g., parallel signals) of the N-point IFFT block 413 to serial signals to generate the serial signals.

The CP addition block 415 may insert a CP into the signals. The UC 416 may up-convert a frequency of the output of the CP addition block 415 to a radio frequency (RF) frequency. Further, the output of the CP addition block 415 may be filtered in baseband before the up-conversion.

The signal transmitted from the transmission path 410 may be input to the reception path 420. Operations in the reception path 420 may be reverse operations for the operations in the transmission path 410. The DC 421 may down-convert a frequency of the received signals to a baseband frequency. The CP removal block 422 may remove a CP from the signals. The output of the CP removal block 422 may be serial signals. The S-to-P block 423 may convert the serial signals into parallel signals. The N-point FFT block 424 may generate N parallel signals by performing an FFT algorithm. The P-to-S block 425 may convert the parallel signals into a sequence of modulation symbols. The channel decoding and demodulation block 426 may perform a demodulation operation on the modulation symbols and may restore data by performing a decoding operation on a result of the demodulation operation.

In FIGS. 4A and 4B, discrete Fourier transform (DFT) and inverse DFT (IDFT) may be used instead of FFT and IFFT. Each of the blocks (e.g. components) in FIGS. 4A and 4B may be implemented by at least one of hardware, software, or firmware. For example, some blocks in FIGS. 4A and 4B may be implemented by software, and other blocks may be implemented by hardware or a combination of hardware and software. In FIGS. 4A and 4B, one block may be subdivided into a plurality of blocks, a plurality of blocks may be integrated into one block, some blocks may be omitted, and blocks supporting other functions may be added.

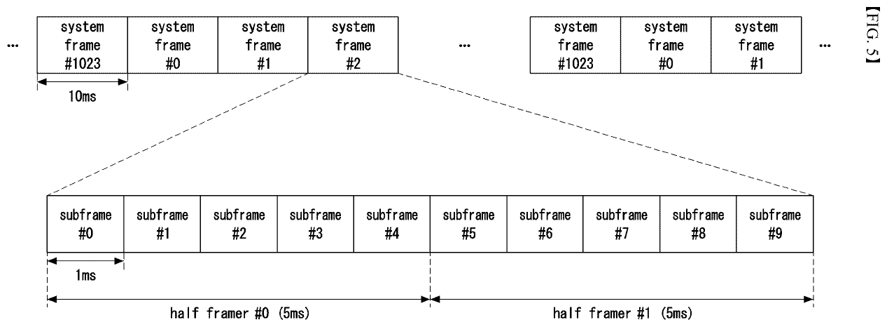

FIG. 5 is a conceptual diagram illustrating a first exemplary embodiment of a system frame in a communication system.

As shown in FIG. 5, time resources in the communication system may be divided on a frame basis. For example, system frames of the communication system may be configured continuously in the time domain. The length of the system frame may be 10 millisecond (ms). A system frame number (SFN) may be set to one of #0 to #1023. In this case, 1024 system frames may be repeated on the time domain of the communication system. For example, an SFN of a system frame after the system frame #1023 may be #0.

One system frame may include two half frames. The length of one half frame may be 5 ms. A half frame located at a starting region of the system frame may be referred to as ‘half frame #0’, and a half frame located at an ending region of the system frame may be referred to as ‘half frame #1’. One system frame may include 10 subframes. The length of one subframe may be 1 ms. 10 subframes within one system frame may be referred to as subframes #0-#9.

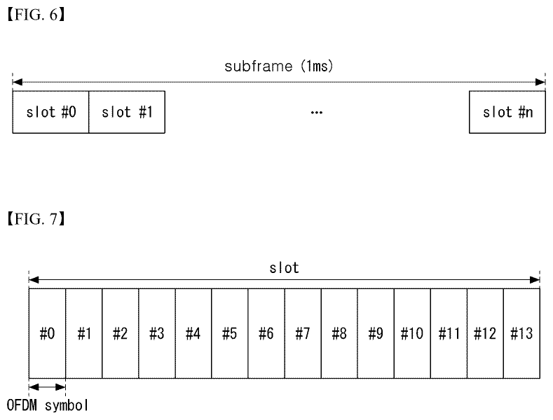

FIG. 6 is a conceptual diagram illustrating a first exemplary embodiment of a subframe in a communication system.

As shown in FIG. 6, one subframe may include n slots, and n may be a natural number. Accordingly, one subframe may consist of one or more slots.

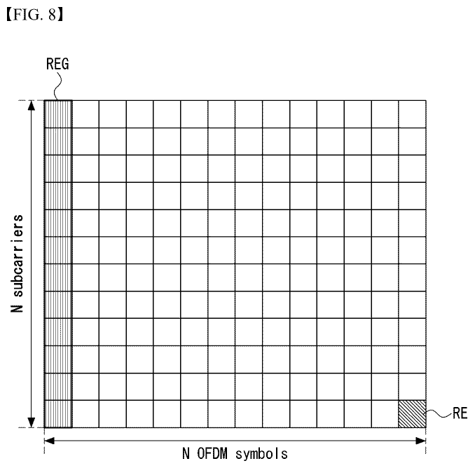

FIG. 7 is a conceptual diagram illustrating a first exemplary embodiment of a slot in a communication system.

As shown in FIG. 7, one slot may include one or more symbols. For example, one slot shown in FIG. 7 may include 14 symbols. The length of slot may vary according to the number of symbols included in a slot and the length of symbol. Alternatively, the length of slot may vary according to a numerology.

The numerology applied to physical signals and channels in a communication system may be variable. The numerology may be adjusted to meet various technical requirements of the communication system. In a communication system where a cyclic prefix (CP)-based OFDM waveform technology is applied, the numerology may include a subcarrier spacing and a CP length (or CP type). Table 1 may illustrate a first exemplary embodiment of a method for configuring numerologies for a CP-OFDM-based communication system. Depending on a frequency band in which the communication system operates, at least some of the numerologies in Table 1 may be supported. Additionally, the communication system may support numerologies not listed in Table 1.

TABLE 1

| | Subcarrier spacing | | | | | |
|---|---|---|---|---|---|---|
| | 15 kHz | 30 kHz | 60 kHz | 120 kHz | 240 kHz | 480 kHz |
| OFDM symbol | 66.7 | 33.3 | 16.7 | 8.3 | 4.2 | 2.1 |
| length [μs] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

When a subcarrier spacing is 15 kHz (e.g. μ=0), the length of slot may be 1 ms. In this case, one system frame may include 10 slots. When a subcarrier spacing is 30 kHz (e.g. μ=1), the length of slot may be 0.5 ms. In this case, one system frame may include 20 slots.

When a subcarrier spacing is 60 kHz (e.g. μ=2), the length of slot may be 0.25 ms. In this case, one system frame may include 40 slots. When a subcarrier spacing is 120 kHz (e.g. μ=3), the length of slot may be 0.125 ms. In this case, one system frame may include 80 slots. When a subcarrier spacing is 240 kHz (e.g. μ=4), the length of slot may be 0.0625 ms. In this case, one system frame may include 160 slots.

The symbol may be configured as a downlink (DL) symbol, flexible (FL) symbol, or uplink (UL) symbol. A slot composed of only DL symbols may be referred to as a ‘DL slot’, a slot composed of only FL symbols may be referred to as a ‘FL slot’, and a slot composed of only UL symbols may be referred to as a ‘UL slot’.

A slot format may be semi-statically configured through higher-layer signaling (e.g. RRC signaling). Information indicating a semi-static slot format may be included in system information, and the semi-static slot format may be configured cell-specifically. Additionally, a semi-static slot format may be further configured for each terminal through terminal-specific higher-layer signaling (e.g. RRC signaling). Flexible symbols in the cell-specific slot format may be overridden to be downlink symbols or uplink symbols through terminal-specific higher-layer signaling. Furthermore, a slot format may be dynamically indicated through physical layer signaling (e.g. slot format indicator (SFI) included in DCI). The semi-statically configured slot format may be overridden by the dynamically indicated slot format. For example, flexible symbols configured semi-statically may be overridden to be downlink symbols or uplink symbols by the SFI.

Reference signals may include Channel State Information-Reference Signal (CSI-RS), Sounding Reference Signal (SRS), Demodulation-Reference Signal (DM-RS), and Phase Tracking-Reference Signal (PT-RS). Channels may include Physical Broadcast Channel (PBCH), Physical Downlink Control Channel (PDCCH), Physical Downlink Shared Channel (PDSCH), Physical Uplink Control Channel (PUCCH), PUSCH (Physical Uplink Shared Channel), PSCCH (Physical Sidelink Control Channel), and PSSCH (Physical Sidelink Shared Channel). In the present disclosure, a control channel may refer to PDCCH, PUCCH, or PSCCH, and a data channel may refer to PDSCH, PUSCH, or PSSCH.

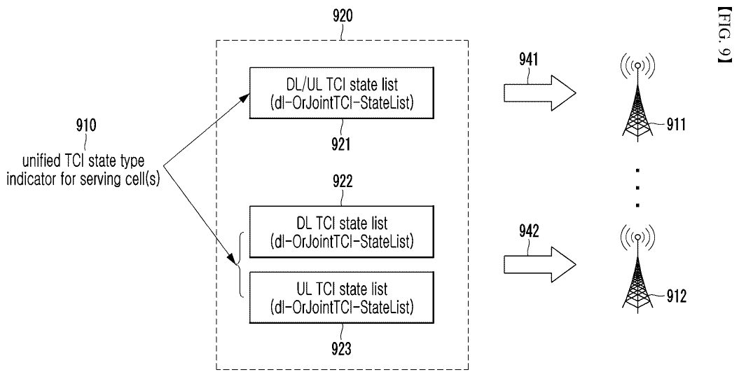

FIG. 8 is a conceptual diagram illustrating a first exemplary embodiment of a time-frequency resource in a communication system.

As shown FIG. 8, a resource composed of one OFDM symbol on the time axis and one subcarrier on the frequency axis may be defined as a ‘resource element (RE)’. A resource composed of one OFDM symbol on the time axis and K subcarriers on the frequency axis may be defined as a ‘resource element group (REG)’. The REG may include K REs. The REG may be used as a basic unit of resource allocation in the frequency domain. K may be a natural number. For example, K may be 12. N may be a natural number. In the slot shown in FIG. 7, N may be 14. N OFDM symbols may be used as a basic unit of resource allocation in the time domain.

In the present disclosure, an RB may refer to a common RB (CRB). Alternatively, an RB may refer to a physical RB (PRB) or a virtual RB (VRB). In a communication system, a CRB may refer to an RB that constitutes a set of contiguous RBs (e.g. a common RB grid) based on a reference frequency (e.g. point A). A carrier and/or bandwidth part may be mapped onto the common RB grid. That is, a carrier and/or bandwidth part may be configured with CRB(s). The RBs or CRBs that constitute a bandwidth part may be referred to as PRBs, and a CRB index may be appropriately converted to a PRB index within the bandwidth part.

Downlink data may be transmitted through a PDSCH. A base station may transmit configuration information (e.g. scheduling information) of the PDSCH to a terminal through a PDCCH. The terminal may obtain the configuration information of the PDSCH by receiving the PDCCH (e.g. Downlink Control Information (DCI)). For example, the configuration information of the PDSCH may include a Modulation Coding Scheme (MCS) used for transmission/reception of the PDSCH, time resource information of the PDSCH, frequency resource information of the PDSCH, and feedback resource information for the PDSCH. The PDSCH may refer to a radio resource where the downlink data is transmitted and received. Alternatively, the PDSCH may refer to the downlink data itself. The PDCCH may refer to a radio resource where the downlink control information (e.g. DCI) is transmitted and received. Alternatively, the PDCCH may refer to the downlink control information itself.

The terminal may perform a monitoring operation for the PDCCH to receive the PDSCH transmitted from the base station. The base station may notify the terminal of configuration information for the PDCCH monitoring operation using a higher-layer message (e.g. Radio Resource Control (RRC) message). The configuration information for the PDCCH monitoring operation may include Control Resource Set (CORESET) information and search space information.

The CORESET information may include PDCCH DMRS information, PDCCH precoding information, and PDCCH occasion information, and the like. A PDCCH DMRS may be a DMRS used for demodulating a PDCCH. A PDCCH occasion refers to a region where a PDCCH may potentially exist, meaning it is a region where DCI can be transmitted. A PDCCH occasion may also be referred to as a PDCCH candidate. The PDCCH occasion information may include time resource information and frequency resource information for the PDCCH occasion. In the time domain, the length of the PDCCH occasion may be indicated in symbol units. In the frequency domain, the size of the PDCCH occasion can be indicated in RB units (e.g. in PRB units or CRB units).

The search space information may include a CORESET identifier (ID) associated with a search space, a periodicity of PDCCH monitoring, and/or an offset of PDCCH monitoring. The periodicity and offset of PDCCH monitoring may each be indicated in slot units. Additionally, the search space information may further include an index of a symbol where the PDCCH monitoring operation starts.

The base station may configure Bandwidth Part(s) (BWP(s)) for downlink communication. The BWP(s) may be configured differently for each terminal. The base station may notify the terminal of BWP configuration information using higher-layer signaling. The higher-layer signaling may refer to a transmission operation of system information and/or a transmission operation of RRC message(s). The number of BWPs configured for a single terminal may be one or more. The terminal may receive the BWP configuration information from the base station and identify the configured BWP(s) based on the received configuration information. When multiple BWPs are configured for downlink communication, the base station may activate one or more BWPs from among the multiple BWPs. The base station may transmit configuration information of the activated BWP(s) to the terminal using at least one of higher-layer signaling, Medium Access Control (MAC) Control Element (CE), or DCI. The base station may perform downlink communication using the activated BWP(s). The terminal may identify the activated BWP(s) by receiving the configuration information from the base station and perform downlink reception operations on the activated BWP(s).

In order to ensure downlink reliability and improve a transmission rate in a cell-edge area in wireless communication systems, the 5G NR of the 3GPP, a standardization body, allows physical channels to be used separately for each transmission and reception point (TRP) or panel, or to be used by being shared among TRPs or panels. Wireless communication employing such a scheme may target use cases such as URLLC and eMBB. In the 3GPP Rel-17, technical discussions and standardization were conducted regarding physical downlink control channel (PDCCH) enhancement to support multi-TRP (mTRP) scenarios. In an mTRP environment, PDCCHs may be transmitted in various manners depending on a deployment to ensure PDCCH reliability for 5G NR. Deployment scenarios for ensuring PDCCH reliability may be broadly classified into two types: single-frequency network (SFN) and non-SFN.

In the case of SFN deployment, different TRPs or different panels may transmit the same PDCCH by utilizing the same time, frequency, and spatial resources. In other words, all the TRPs can transmit PDCCHs using the same demodulation reference signal (DMRS) configuration, position, and sequence. In this case, from a reception perspective, transmission configuration indicator (TCI) states for TRPs or panels may be implicitly configured differently. In other words, the technical specifications do not support explicit indication and/or configuration methods for TCI states with respect to the TRPs or panels from the reception perspective. In the SFN deployment, for a control resource set (CORESET) that is used for communication between multiple TRPs or multiple panels and one user equipment (UE), multiple TCI states may be configured. When multiple TCI states are configured for multiple TRPs or multiple panels communicating with one UE in this manner, constraints may be imposed when synchronization between TRPs is performed using ideal backhaul or near-ideal backhaul.

In the case of non-SFN deployment, methods for each of the TRPs to transmit a PDCCH to a UE may be classified into two types below.

First, PDCCHs fully generated at the respective TRPs may be transmitted to the UE either within the same CORESET or within different CORESETs. In this case, when the respective TRPs transmits the PDCCHs to the UE, the PDCCHs may be transmitted by being multiplexed in the time and/or frequency domain. This scheme may be referred to as a multi-TRP based PDCCH repetition scheme.

Second, a scheme may be employed in which encoded bits to be transmitted through a single PDCCH are divided into multiple parts, and the respective TRPs transmit the multiple parts through different PDCCH candidates. This scheme may be referred to as a single TRP based PDCCH transmission scheme.

The first scheme is a scheme of repeatedly generating PDCCHs as many as the number of TRPs, and transmitting the PDCCHs using the same search space index within different search space sets having the same number of PDCCH candidates. In this case, the search space sets may exist within the same CORESET. As another example, the search space sets may exist within different CORESETs. According to the 3GPP technical specifications, only one TCI state may be associated with one CORESET. Therefore, if the PDCCHs are transmitted in different search spaces within the same CORESET, only one TCI state can be indicated and/or configured for two PDCCHs at a specific time. Therefore, the UE can receive only a PDCCH for one TRP at the specific time.

On the other hand, if the PDCCHs are transmitted using the same search space index within different CORESETs, the UE may receive a PDCCH from a single TRP or may receive multiple PDCCHs from multiple TRPs, depending on the number of TCI states indicated and/or configured by the base station. The reception of multiple PDCCHs from multiple TRPs by the UE in the above-described manner may be an implicit operation without explicit indication and/or configuration.

The second scheme is a scheme of splitting a single PDCCH into split-PDCCHs as many as the number of TRPs transmitting the split-PDCCHs through different PDCCH candidates. In other words, an aggregation level of each split-PDCCH and a combined aggregation level after combining the split-PDCCHs are the same.

The second scheme also allows allocation of the PDCCHs to different CORESETs. Since a payload obtained by the UE receiving and combining the split-PDCCHs distributed across different CORESETs is the same as a payload of a single PDCCH transmitted from a single TRP to the UE, the second scheme has an advantage in terms of decoding complexity compared to the first repetition scheme.

Meanwhile, in the 3GPP Rel-18 standardization, it was decided that a unified TCI framework, which was designed in the 3GPP Rel-17 for single TRP (sTRP) scenarios, would also be applied to multi-TRP (mTRP) scenarios. Therefore, detailed discussion is required to apply the unified TCI framework, which targets sTRP scenarios, to mTRP scenarios. In addition, on a user equipment (UE) side, time is required to configure a beam when updating a TCI state that is indicated and/or configured. In this case, the time required to configure a beam may be defined by a beam application time (BAT). Since a duration of the BAT was defined by the 3GPP targeting sTRP scenarios, issues that may occur when the BAT is extended to mTRP scenarios and corresponding solutions should be addressed.

Hereinafter, the present disclosure describes methods and apparatuses for solving the above-described issues.

First, in the 3GPP Rel-18 standardization, no agreement has been made on a scheme that supports simultaneous configuration of joint and separate DL/UL TCI state types in serving cell(s) with respect to extension of the unified TCI framework. In addition, no agreement has been made on a scheme that supports separate RRC-configured TCI state list(s) for each TRP.

In the 3GPP Rel-17 standardization, a TCI state list configuration scheme for sTRP scenarios was discussed. The maximum number of TCI states configured for sTRP scenarios may vary depending on a UE capability. For DL or joint TCI states, it was agreed that the maximum number of configured TCI states is 128. For UL TCI states per BWP per CC, it was agreed that the maximum number is 64.

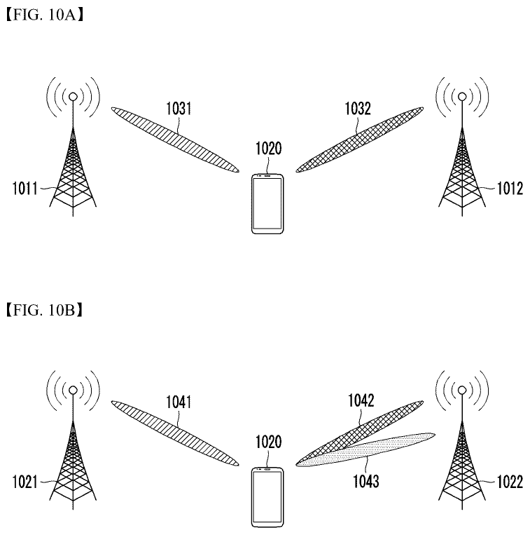

FIG. 9 is a conceptual diagram illustrating a scenario in which a TCI state pool is extended from a single TRP to multiple TRPs.

As shown in FIG. 9, a case is illustrated in which multiple TRPs 911 and 912 form serving cell(s) for a specific UE. For the multiple TRPs 911 and 912, a TCI state list included in a unified TCI state set 920 may be configured according to a unified TCI state type indicator 901. The unified TCI state set 920 may also be referred to as a TCI state pool.

The unified TCI state set 920 may include a TCI state list 921 that can be commonly applied to both DL and UL when a joint DL/UL TCI state type is configured. In addition, when a separate DL/UL TCI state type is configured, the unified TCI state set 920 may include a DL TCI state list 922 applicable to DL and a UL TCI state list 923 applicable to UL. In other words, when the first TRP 911 is configured to use a joint DL/UL TCI state type, the TCI state list 921 that is jointly used for DL and UL may be configured for the first TRP 911. As another example, when the first TRP 911 is configured to a separate DL/UL TCI state type, the DL TCI state list 922 may be configured for DL of the first TRP 911, and the UL TCI state list 923 may be configured for UL of the first TRP 911. Such a configuration method may also be applied to other TRPs.

The TCI state lists 921 to 923 included in the unified TCI state set 920 may be configured by a unified TCI state type indicator 910 for the serving cell(s). Therefore, depending on the unified TCI state type indicator, one (in the case of ‘joint’) or two (in the case of ‘separate’) TCI state lists may be configured per TRP.

However, according to the current standards, there is no specification on whether a joint DL/UL TCI state type (mode) or a separate DL/UL TCI state type (mode) is to be configured for each of the multiple TRPs. In other words, as illustrated with dotted arrows such as reference numerals 941 and 942, a scheme for configuring TCI state list(s) for each of the multiple TRPs that are serving cell(s) for a specific UE is not provided.

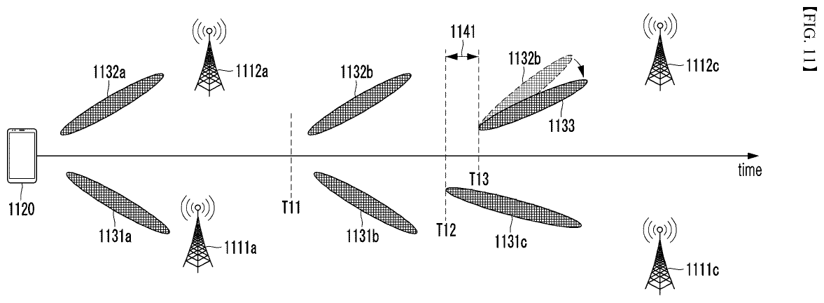

FIG. 10A is a conceptual diagram illustrating a case where the same TCI state type is configured for two TRPs, and FIG. 10B is a conceptual diagram illustrating a case where different TCI state types are respectively configured for two TRPs.

As shown in FIG. 10A, a case is illustrated in which a first TRP 1011 and a second TRP 1012 communicate with the same UE 1020. In other words, the first TRP 1011 may communicate with the UE 1020 through a DL/UL beam 1031, and the second TRP 1012 may communicate with the UE 1020 through a DL/UL beam 1032. In this case, the first TRP 1011 and the second TRP 1012 may have the same TCI state type. In other words, the example of FIG. 10A may correspond to an example in which multiple TRPs 1011 and 1012 communicate with one UE 1020 using the same TCI state type.

In an mTRP scenario, the respective TRPs may be deployed at geographically different locations, and a connection quality between the UE and each TRP may vary. Therefore, each TRP may need to be configured with a different TCI state type. This is described with reference to FIG. 10B.

As shown in FIG. 10B, a case is illustrated in which a first TRP 1021 and a second TRP 1022 communicate with the same UE 1020. According to FIG. 10B, the first TRP 1021 may communicate with the UE 1020 through a DL/UL beam 1041, the second TRP 1022 may transmit control signals and/or data to the UE 1020 in DL through a DL beam 1042, and receive control signals and/or data from the UE 1020 in UL through a UL beam 1043. Therefore, in the case of FIG. 10B, each of the first TRP 1021 and the second TRP 1022 may have a different TCI state type. In other words, the example of FIG. 10B may correspond to an example in which multiple TRPs 1021 and 1022 communicate with the one UE 1020 using different TCI state types.

The case illustrated in FIG. 10B may be understood as a case in which TCI state types suitable for the respective TRPs are configured due to differences in distances, channel environments, or channel reciprocities between the UE and the TRPs. From this perspective, it may be more preferable to configure TCI state types separately for the respective TRPs rather than applying the same TCI state type to all TRPs.

To support this, it may be preferable to consider simultaneous configuration of joint and separate DL/UL TCI state lists such as {a list for the joint TCI state type and lists for the separate TCI state type}.

Meanwhile, a base station may activate or deactivate a TCI state for a serving cell set simultaneously through a MAC-CE. For example, when a serving cell set ID is configured in the MAC-CE, the indicated TCI state may be activated or deactivated for all serving cells within the serving cell set indicated by the serving cell set ID. In this case, information on serving cell set(s) may be provided through RRC signaling. According to the current 3GPP technical specifications, up to 4 serving cell sets may be provided through RRC signaling. For example, respective TCI state update lists may be configured as {simultaneousU-TCI-UpdateList1, simultaneousU-TCI-UpdateList2, simultaneousU-TCI-UpdateList3, or simultaneousU-TCI-UpdateList4}.

From the perspective of signaling overhead, the simultaneous activation or deactivation mechanism as described above may also be applied when configuring TCI state types in an mTRP environment.

### First Exemplary Embodiment: Method for Configuring TCI State Types for TRPs

A TCI state pool (or TCI state list) related to TRPs that may be used for unified TCI state indication of mTRP may be as described in FIG. 9. In other words, in the present disclosure, the TCI state pool may be used in the same sense as the TCI state list. The TCI state pool or TCI state list is a set of TCI states, and the TCI states included in the TCI state list may be jointly applied to DL and UL or separately applied to DL and UL according to the TCI state type.

Basically, a base station may configure either two TCI state lists or one TCI state list for a TRP according to a TCI state type of the TRP. In this case, when multiple TRPs are connected to the base station (i.e. in the case of mTRP scenario), for the reasons described above, the base station may configure a TRP such that both the joint DL/UL TCI state type and the separate DL/UL TCI state type are available to the TRP, rather than only one of the two types.

In the present disclosure, it should be noted that allowing the base station to use both TCI state types for specific TRP(s) does not mean configuring additional TCI state lists. Allowing the base station to use both TCI state types for specific TRP(s) may mean that all state lists related to the joint DL/UL TCI state type and the separate DL/UL TCI state type can be used by the specific TRP(s). In other words, assuming the example shown in FIG. 9, the base station may configure TRP(s) to use all of the DL/UL TCI state list 921, the DL TCI state list 922, and the UL TCI state list 923. As a result, the base station may configure common TCI state lists that can be used in each of the TRP(s) serving as serving cell(s), regardless of each TRP's TCI state type.

As an example of the above-described situation, when the base station configures TCI state lists to each of the TRP(s) through RRC signaling, the base station may always configure all TCI state lists associated with the joint DL/UL TCI state type and the separate DL/UL TCI state type. However, the TCI state type configuration may differ for each TRP or TRP group. In this case, configuration schemes for a TCI state type per TRP or TRP group according to the present disclosure are described.

### 1.1 Method of Configuring a TCI State Type Per TRP

In the present disclosure, a TCI state type may be separately configured for each TRP. When N TRPs are connected to a base station, the base station may respectively configure (or indicate) N TCI state types to the TRPs using RRC signaling. For example, it may be assumed that the base station configures the TCI state types through RRC signaling as follows.
TCI state types={‘separate’, ‘joint’, ‘separate’, ‘separate’, . . . }

When the TCI state types are configured as above, one TCI state type may be mapped one-to-one to one TRP in the order of the TRPs. In other words, a first TRP configured first through RRC signaling may be configured to use TCI state lists based on the separate DL/UL TCI state mode (or type), and a second TRP configured second through RRC signaling may be configured to use a joint TCI state list according to the joint TCI state mode (or type). Therefore, the first TRP may use a DL TCI state list and a UL TCI state list, and the second TRP may use a joint DL/UL TCI state list.

In the above example, each of the first TRP and the second TRP may be defined according to an order of TRP indexes configured through RRC signaling. In another example, a predefined TRP index may be assigned to each of the first TRP and the second TRP. When assigning an index to each TRP, indexes may be arranged in ascending order, descending order, or in an arbitrary (random) order. Here, examples of indexes may include any one of a TRP identifier (ID), a CORESET ID, a CORESET group ID, or a search space ID as parameters for distinguishing TRPs. Therefore, indexes may refer to specific parameter values arranged in order. In the following description, a case is assumed in which TRP IDs are used for convenience of description.

### 1.2 Method of Configuring a TCI State Type Per TRP Group

In the present disclosure, a TCI state type may be configured for each TRP group. As described above, assuming that N TRPs are connected to a base station, the base station may divide the N TRPs into M groups. In this case, M may be a value less than or equal to N. The base station may provide group information on the N TRPs divided into M groups to each of the TRPs through RRC signaling. Then, the base station may configure (or indicate) a TCI state type for each of the M groups individually. This may be described by an example.

It may be assumed that four TRPs are connected to the base station, and the base station divides them into two TRPs each, or three TRPs and one TRP as a first group and a second group, respectively. Information on such groups may be pre-transmitted to the four TRPs by the base station. Subsequently, the base station may configure a TCI state type for each of the first group and the second group through RRC signaling as follows.

$$First TRP group ( TRP group \#1 ) = \{ TRP \#1 , TRP \#3 \} = ‘ separate ’ TCI state type$$

$$Second TRP group ( TRP group \#2 ) = \{ TRP \#2 , TRP \#4 \} = ‘ joint ’ TCI state type$$

When the TCI state types are configured as described above, TRPs included in the first group and the second group may receive TCI state lists based on RRC signaling. Therefore, information on the groups and information on the TCI state lists may be transmitted together through RRC signaling during group configuration.

All TRPs included in the same group among the M groups may have the same TCI state type. Accordingly, the base station may activate or deactivate a TCI state type per TRP group. When the base station activates or deactivates a TCI state type per TRP group, the base station may indicate activation or deactivation of the TCI state type per TRP group by simultaneously transmitting a MAC-CE or DCI to TRPs belonging to the TRP group. This may be understood through the following example.

Assume a case in which TRPs included in the first TRP group (TRP group #1) are {TRP #1, TRP #3, TRP #4}, and TRPs included in the second TRP group (TRP group #2) are {TRP #2}. In this case, assume that the first TRP group (TRP group #1) is configured with a joint DL/UL TCI state type, and the second TRP group (TRP group #2) is configured with a separate DL/UL TCI state type. In this case, when the base station transmits one TRP ID (e.g. a third TRP ID (TRP ID #3)) through a MAC-CE or DCI, the MAC-CE or DCI may be understood to indicate a TCI state type update for all TRPs included in the first TRP group to which the third TRP belongs. In other words, when the base station indicates the third TRP ID in the MAC-CE or DCI and indicates the TCI state type update, the third TRP (TRP #3) as well as the other TRPs in the first TRP group, the first TRP (TRP #1) and the fourth TRP (TRP #4), may recognize that the TCI state type update has been indicated for them equally.

When the base station separately configures and uses TRP group IDs, the base station may directly configure a TRP group ID in a field of the MAC-CE or DCI instead of a specific TRP ID, thereby indicating activation or deactivation of a TCI state type simultaneously for multiple TRPs included in a TRP group indicated by the TRP group ID.

### 1.3 Method of Configuring TCI States for TRP Groups Based on TCI State Types

In another exemplary embodiment of the present disclosure, it may be possible to configure TCI states for TRP groups based on TCI state types. This may also be understood as a sub-embodiment of Section 1.2 described above. Then, a method for configuring TCI states for TRP groups is described.

The base station may classify multiple TRPs based on two TCI state types, that is, {joint, separate}. To this end, the base station may indicate the TCI state types of the TRPs in a bitwise form. For example, by predefining that ‘0’ represents the joint TCI state type and ‘1’ represents the separate TCI state type, the base station may indicate the TCI state types for N TRPs by using N bits. A specific example of this is described below.

It may be assumed that four TRPs are connected to the base station, and indexes of the TRPs are TRP #1, TRP #2, TRP #3, and TRP #4. Based on this assumption, the base station may configure ‘1110’ in a MAC-CE or DCI based on the order of the indexes of the TRPs, thereby activating or deactivating TCI state types for the respective TRPs. When the base station indicates ‘1110’ through RRC signaling, the TRP #1, TRP #2, and TRP #3 may be configured with the separate TCI state type. Furthermore, the base station may indicate activation or deactivation for TCI state lists individually configured for each of the TRP #1, TRP #2, and TRP #3 through a MAC-CE or DCI. Therefore, based on the RRC signaling, the TRP #1, TRP #2, and TRP #3 may each be configured with the separate TCI state type. Thereafter, each of the TRP #1, TRP #2, and TRP #3 may activate or deactivate the individually configured TCI state lists through the MAC-CE or DCI received from the base station. In addition, based on the above RRC signaling, the TRP #4 may be understood to use TCI states included in a joint TCI state list that may be used regardless of DL and UL.

The method described above may be understood as grouping TRPs based on TCI state types. In other words, it may be possible to configure or indicate a TCI state type update through a 1-bit value set to ‘0’ or ‘1’. In other words, the 1-bit information may be transmitted through a reserved bit of the MAC-CE. In addition, using the reserved bit values of the MAC-CE, it may be possible to indicate activation or deactivation of TCI states simultaneously for two groups through the on or off states of TCI states.

The method described above may be regarded as dividing multiple TRPs into two simultaneous TRP update lists. The simultaneous TCI state update may be used in the same manner as the method described in Section 1.2.

In the present disclosure, activation/deactivation and indication may be distinguished as follows. When each TCI state is mapped to one codepoint and all of a plurality of codepoints are activated or deactivated, the term ‘activation/deactivation’ may be used. In addition, when one specific codepoint among the plurality of codepoints is indicated to directly indicate a TCI state change, the term ‘indication’ may be used.

### Second Exemplary Embodiment: TCI State Configuration Method According to an Overlap Between a BAT Duration and a Physical Channel

Before describing a second exemplary embodiment, the beam application time (BAT) is described.

The beam application time (BAT) was introduced in the 3GPP standard Release 17. The beam application time is used to indicate the first slot in which an indicated TCI state is applied when the indicated TCI state differs from a previously indicated one. The BAT in the 3GPP technical specifications requires a more explicit description and additional refinement. For a case where a scheduled DL channel and/or UL channel exists during a time duration defined by the BAT, no description is currently provided regarding an operation for the scheduled DL and/or UL channel. Intuitively, schemes that a UE may selectively use may be as follows.

First, a scheme may be used in which the UE transmits the scheduled physical channel by applying the previously indicated TCI state.

Second, a scheme may be used in which the UE does not transmit the scheduled physical channel during the time duration defined by the BAT.

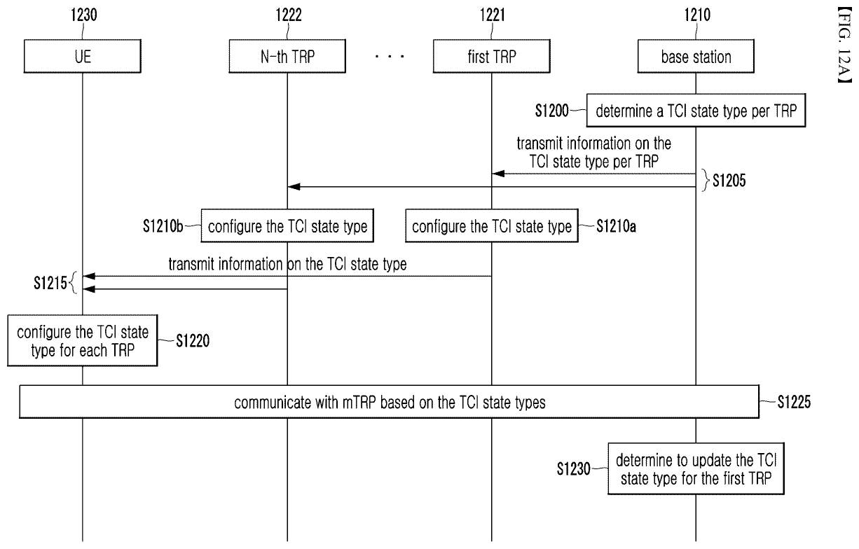

In the first case, the performance of the scheduled channel may be degraded. On the other hand, in the second case, transmission of the scheduled channel may be delayed. In addition, a time duration during which the scheduled DL and/or UL channel overlaps with the time duration defined by the BAT may occur. The overlapping time duration is described below with reference to FIG. 11.

FIG. 11 is a conceptual diagram illustrating a case where a TCI state change of one TRP is indicated in an environment where multiple TRPs communicate with a UE.

In FIG. 11, the horizontal axis may represent time. Also, a UE 1120 is assumed to be communicating with a first TRP 1111 and a second TRP 1112.

In FIG. 11, reference numerals of the TRPs 1111 and 1112 are provided with suffixes a, b, and c after the reference numerals to identify communication timings with the UE 1120. In other words, reference numerals 1111a and 1112a are used to indicate that the TRPs 1111 and 1112 communicate with the UE 1120 at a first time. Then, at the first time, the UE 1120 may transmit a channel or signal in a UL to the first TRP 1111a using a first beam 1131a. The channel or signal transmitted in the UL may be one of a PUSCH, PUCCH, or SRS. Also, at the first time, the UE 1120 may transmit a channel or signal in a UL to the second TRP 1112a using a first beam 1132a. The channel or signal transmitted in the UL may also be one of a PUSCH, PUCCH, or SRS.

A case is assumed where a TCI state update for the second TRP 1132 is indicated at a time T11. The TCI state update for the second TRP 1132 may be indicated to the second TRP 1132 by the base station. Thereafter, the second TRP may indicate the TCI state update to the UE 1120. A time immediately after the TCI state update is indicated is referred to as a second time.

When the TCI state update is indicated from the second TRP 1112, the UE 1120 may need to transmit a response thereto through the UL. It is also assumed that there is no TCI state change for the first TRP 1111. Then, at the second time, the UE 1120 may transmit a UL channel to the first TRP (the first TRP at the second time is not shown in FIG. 11) using a second beam 1131b. The UL channel may be a PUSCH and/or PUCCH. In addition, at the second time, the UE 1120 may transmit a UL channel to the second TRP (the second TRP at the second time is not shown in FIG. 11) using a second beam 1132b. In this case, the UL channel may be a PUSCH and/or PUCCH.

The second beam 1131b transmitted by the UE 1120 to the first TRP at the second time may be the same as the first beam 1131a transmitted by the UE 1120 to the first TRP at the first time. In addition, the second beam 1132b transmitted by the UE 1120 to the second TRP at the second time may be the same as the second beam 1131b transmitted by the UE 1120 to the second TRP at the first time. The example of FIG. 11 assumes such a situation.

In addition, the UE 1120 may have a BAT for changing the beam to be transmitted to the second TRP from a time T12 to a time T13. In this case, the UE 1120 may transmit a PUCCH and/or PUSCH in the UL at the time T12 to the first TRP 1111c through a first beam 1131c that is the same as the first beam 1131a at the first time and the first beam 1131b at the second time.

However, since the UE 1120 needs to change the beam to be transmitted to the second TRP from the time T12 to the time T13, after the time T13, the UE 1120 may transmit a PUCCH and/or PUSCH in the UL to the second TRP 1112c through a third beam 1133 different from the second beam 1132a at the first time and the second beam 1132b at the second time.

According to the scheme described with reference to FIG. 11 above, the TCI state update transmitted at the time T11 may be indicated to the UE 1120 through a MAC-CE, DCI, or PDSCH. In addition, the UE 1120 may transmit a response thereto to the second TRP 1112 and/or the base station (not shown in FIG. 11) through a PUCCH or PUSCH.

Upon receiving the TCI state update transmitted at the time T11, the UE 1120 may determine a time at which the updated TCI state is applied when the indicated TCI state is different from the currently configured TCI state, as follows. The UE 1120, upon receiving the TCI state update indication, may transmit the response thereto to the TRP and/or the base station through a PUSCH or PUCCH. The time at which the indicated TCI state is applied may be a time after a duration defined by the BAT set by the base station through RRC signaling from the last symbol of the PUSCH or PUCCH transmitted to respond to the TCI state indication. In other words, the time T13 may be a time after the duration defined by the BAT set by the base station through RRC signaling from the last symbol of the PUSCH or PUCCH transmitted to respond to the TCI state indication.

Since the BAT depends on the UE capability, it may be set uniformly among the TRPs or set on a TRP group basis as described in Section 1.2 above. This is because activation or deactivation of the simultaneous TCI state for a plurality of TRPs may be performed on a TRP group basis.

Hereinafter, the relationship between the BAT and a DL or UL channel, as well as the operations of the UE and the base station based on this relationship, are described. In addition, the operations of the UE and the base station may differ depending on whether there is an overlap between them. The following sections describe these aspects in further detail.

2.1 Case where a BAT Duration Fully Overlaps with a Configured Physical Channel (CASE #1)

As described in FIG. 11, it may be confirmed that a BAT is required for the UE to change the beam based on the TCI state. In addition, as described above, the base station may configure a BAT for each TRP group based on the UE capability.

In this case, if a configured physical channel exists within a duration defined by the BAT, operations of the UE and the base station may be largely classified into two cases below.

First, the configured physical channel may be transmitted using a currently configured TCI state.

Second, the base station does not configure resources according to the TCI state, and accordingly, the UE does not expect transmission or reception of a channel and/or signal within the corresponding duration.

In the first case, performance loss may occur, while in the second case, latency issues may arise.

First, a case is described in which the base station and the UE transmit and receive the configured physical channel by applying the existing TCI state as a default behavior. In this case, the base station may transmit, to the UE, an on/off indication on whether to use the configured physical channel, considering the performance loss and power consumption of the UE. The information on whether to use the configured physical channel may be transmitted through a MAC-CE and/or DCI that activates/deactivates or indicates the TCI state.

As a first scheme, an indicator of whether to use the configured physical channel may be indicated regardless of a TRP environment, such as an mTRP environment or an sTRP environment.

As a second scheme, due to characteristics of the mTRP environment in which links between the UE and the TRPs are all independent, the indicator of whether to use the configured physical channel needs to be configured or indicated per TRP or per TRP group, and may also be delivered through a MAC-CE or DCI on a per-TRP or per-TRP group basis.

As an example of the second scheme, regarding configuration of a minimum required time gap for a physical channel, an additional BAT value per channel may be required. Therefore, a minimum time required for each physical channel transmission may be determined as follows.

### [Minimum Time Required for Physical Channel Transmission]

A minimum time between the last symbol of PDSCH reception and the first symbol of PUCCH transmission including HARQ-ACK information is as shown in Equation 1 below.

$${N}_{T , 1} + 0.5 msec \qquad [ Equation 1 ]$$

In Equation 1, N_{T,1} denotes a duration of N₁ symbols corresponding to a PDSCH processing time for a UE processing capability 1, in a case where additional PDSCH DM-RS is configured. Here, when μ=0, it is assumed that N_{1,0}=14. In Equation 1, 0.5 msec may be a margin value. Therefore, Equation 1 may be determined as a sum of the processing time N_{T,1}, which is determined by the UE capability and a symbol duration, and the margin value.

When the base station needs to perform configuration considering the UE's BAT, as in the second example, it is additionally necessary to consider the BAT in calculation of a minimum required time T_{q}. Assuming this applies to the case of PUCCH transmission, the minimum required time T_{q} may be calculated as shown in Equation 2 below.

$${T}_{q} = N + 0.5 + BAT \qquad [ Equation 2 ]$$

As shown in Equation 2, in the second example, the BAT needs to be additionally considered.

Taking the above-described content into overall consideration, the following two situations may be broadly considered.

(1) Prohibition of UL Transmission and/or DL Transmission

The first situation is where DL transmission and UL transmission may both be prohibited, only UL transmission may be prohibited, or only DL transmission may be prohibited within the duration defined by the BAT (i.e. BAT duration). This prohibition method may be configured by the base station using system information or higher-layer signaling, or may be predefined according to technical specifications.

More specific methods therefor are described. In describing of a first example, UL transmission may be used as a basis for description for convenience. However, the same may apply to DL transmission. It should be noted that a DL transmission time may be determined in the same manner as described below, since the base station knows the UE's BAT based on the UE capability information received in advance from the UE.

When UL transmission and/or DL transmission is prohibited by agreement according to technical specifications or by system information or higher-layer signaling, the UE may not perform UL transmission within the BAT duration. In addition, the UE may not expect DL transmission within the BAT duration. That the UE does not expect DL transmission within the BAT duration may mean that the UE does not perform an operation for DL reception within the BAT duration.

As described above, when UL transmission and/or DL transmission is prohibited within the BAT duration, a definition of a time for the UE to resume UL transmission is required. In other words, as in the example described above, the UE may need to transmit a PUCCH or PUSCH including HARQ-ACK information, but a transmission time of the PUCCH and/or PUSCH may fall within the BAT duration. In such cases, transmission of the PUCCH and/or PUSCH cannot be performed simply by considering the BAT or based on Equation 1. If the UL transmission is performed based on Equation 1, the UL transmission may fall within the BAT duration. In addition, if only the BAT duration is considered, preparation for the transmission of the PUCCH and/or PUSCH may not be completed.

Therefore, the present disclosure proposes a transmission time calculation method based on Equation 2. Accordingly, the UE may not only avoid the BAT duration by transmitting the PUCCH and/or PUSCH after a time exemplified in Equation 2 elapses, but may also perform UL transmission in a state in which preparation for the transmission of the PUCCH and/or PUSCH is completed.

(2) Allowance of UL Transmission and/or DL Transmission

The second situation is where UL and/or DL transmission may be performed within the BAT duration. When UL and/or DL transmission is performed within the BAT duration, transmission schemes may be classified as follows. Examples thereof are described based on UL transmission. However, the same may apply to DL transmission. It should be noted that a DL transmission time may be determined in the same manner as described above, since the base station knows the UE's BAT based on the UE capability information received in advance from the UE.

A case where UL transmission is allowed within the BAT duration and the UE needs to transmit a PUCCH and/or PUSCH within the BAT duration may occur. Since the BAT duration is a time duration during which the UE needs to configure a new beam based on a TCI state change, the new beam may not yet be configured within the BAT duration. Therefore, when the UE transmits the PUCCH and/or PUSCH within the BAT duration, the UE may transmit the PUCCH and/or PUSCH using a beam prior to the TCI state change.

If the PUCCH and/or PUSCH transmitted by the UE continues beyond the BAT duration, the UE may transmit the PUCCH and/or PUSCH using two beams. In other words, as described above, the new beam may not be configured within the BAT duration. Therefore, for the PUCCH and/or PUSCH transmitted within the BAT duration, the UE may use the beam prior to the TCI state change. For the PUCCH and/or PUSCH transmitted after the BAT duration, the UE may use the newly configured beam based on the TCI state change.

2.2 Case where a BAT Duration Partially Overlaps with a Configured Physical Channel (CASE #2)

Meanwhile, a BAT duration and a physical channel may partially overlap without being completely overlapped. In other words, a case may occur where a duration defined by the BAT configured through RRC signaling by the base station and a periodically transmitted or scheduled DL physical channel and/or UL physical channel partially overlap. This may correspond to a case where the DL physical channel and/or UL physical channel needs to be transmitted within a part of a time resource between the time T12 and time T13 described in FIG. 11. Such cases may also be classified into two major cases as in CASE #1 described above.

If the overlapping resource is used between the UE and the base station, this may be understood as a form in which different beams are formed for transmission/reception of a single physical channel. In such a case where different beams are formed, if the transmission is for a signal such as CSI or SRS that requires channel measurement, a problem of inaccurate channel measurement may occur. Therefore, as described in CASE #1, a method of indicating whether to transmit or receive the physical channel/signal may be used. As another method, the base station may configure overlapping symbols or overlapping slots (e.g. window) and transmit the configuration to the UE in advance through system information or RRC signaling. Accordingly, the UE that has obtained the information on the overlapping symbols or overlapping slots may use a TCI state prior to the TCI state update for the physical channel transmitted in the overlapping duration (i.e. a time resource before the end of the BAT duration), and may apply the updated TCI state from a time after the end of the BAT duration.

As another example, based on the information on the overlapping symbols or overlapping slots, the UE may be configured (or may be expected) not to transmit or receive the physical channel in the time resource before the end of the BAT duration.

As yet another example, the UE may transmit the physical channel in the uplink through the overlapping resource until the end of the BAT duration using the TCI state prior to the TCI state update.

The UE may report to the base station in advance information on whether to use the overlapping symbols or overlapping slots, based on UE capability information. In addition, the base station may recognize whether the BAT duration and a physical channel to be transmitted or received overlap. Accordingly, the base station may transmit information on whether to continue using the previous TCI state to the UE by including it in TCI state update indication information or by including it in channel scheduling information.

The UE may determine whether to transmit or receive the physical channel that partially overlaps with the BAT duration in the time resource before the end of the BAT duration, based on the information indicating whether to continue using the previous TCI state. For example, when the information indicating whether to continue using the previous TCI state instructs to use the physical channel that partially overlaps with the BAT duration, the UE may use the TCI state prior to the TCI state update in the time resource before the end of the BAT duration, and may transmit or receive the physical channel based on the updated TCI state after the end of the BAT duration.

Meanwhile, the information indicating whether to continue using the previous TCI state may be transmitted to the UE through a MAC-CE or DCI, rather than through the TCI state update information or channel scheduling information. As another example, the technical specifications may predefine whether to use or not use each physical channel in the overlapped duration. In such a predefined case, the UE may operate based on the predefined rule.

On the other hand, when the above-described window is used, a size of the window may be individually defined per channel or per channel group. The window may be commonly configured for each CC or BWP to reduce signaling overhead. In addition, the window and the indicator may also be signaled to each TRP. Therefore, the window and the indicator may be configured per TRP through a MAC-CE or DCI.

Channels that use the previous TCI state based on the information indicating whether to continue using the previous TCI state may be configured to have a different priority from other channels. For example, the channels that continue to use the previous TCI state may be configured to have a higher priority than other channels. As another example, since links between the UE and the respective TRPs are different, priorities for the links may be configured differently.

Also, as described in Section 2.1 above, when the duration overlapping with the BAT duration ends, a signal for UL transmission and/or DL transmission may be transmitted at the time calculated based on Equation 2.

The first exemplary embodiment and the second exemplary embodiment described above may be commonly applied to DL channels and/or UL channels. Also, the UE may include information indicating whether each of the above-described exemplary embodiments is supported in a UE capability report and may transmit this information to the base station in advance. Accordingly, the base station may configure (or indicate) application of the first and/or second exemplary embodiments differently for each UE, based on the UE capability report received from the UE.

Furthermore, both s-DCI and m-DCI may be used as the DCI described in the above exemplary embodiments. In addition, in the first and second exemplary embodiments related to the PUCCH resources described above, the base station may transmit information on the associated TRP to the UE. The UE may also report information on the associated TRP to the base station. In this case, the information on the TRP may be information indicating a uniqueness of the TRP, such as a TRP ID or a CORESET group ID. This is because the PUCCH resource is implicitly configured, and thus it is required to include information on which TRP the response corresponds to.

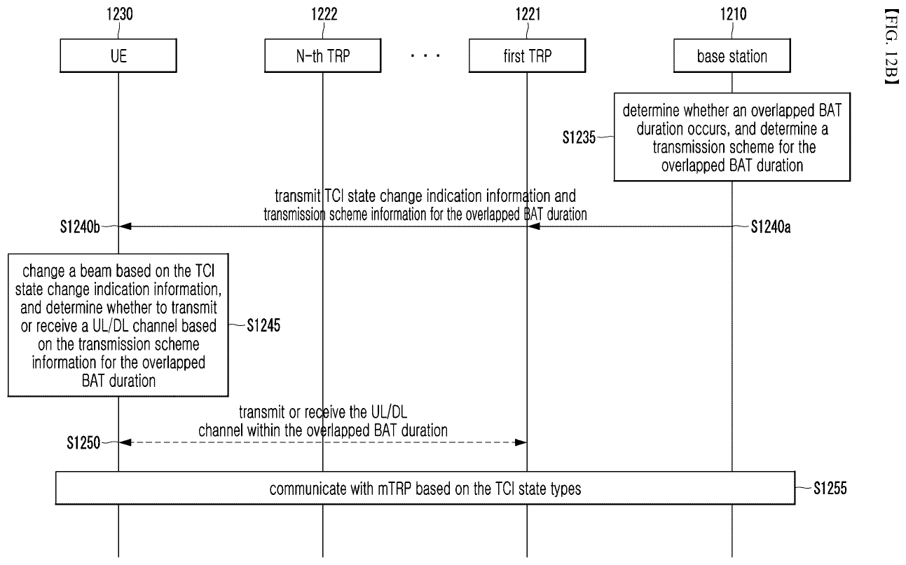

FIG. 12A is a partial sequence chart illustrating a case where the second exemplary embodiment is applied after the first exemplary embodiment according to the present disclosure, and FIG. 12B is a remaining sequence chart illustrating the case where the second exemplary embodiment is applied after the first exemplary embodiment according to the present disclosure.

As shown in FIG. 12A and FIG. 12B, a plurality of TRPs 1221, . . . , and 1222 connected to a base station 1210 and a UE 1230 are illustrated. Therefore, FIG. 12A and FIG. 12B assume a case where the UE 1230 is capable of communicating with the plurality of TRPs 1221, . . . , and 1222 based on TCI state type(s).

In the following description, a case is assumed in which whether to allow DL and/or UL transmission within the BAT duration is predetermined. In other words, according to the technical specifications, it may be determined that DL and/or UL transmission is not possible within the BAT duration. In this case, the base station 1210 may not need to provide separate signaling or configuration information to the TRPs 1221 and 1222 and the UE 1230. As another example, the base station 1210 may allow or prohibit DL and/or UL transmission within the BAT duration. In such cases, the base station 1210 may inform the TRPs 1221 and 1222 and the UE 1230 in advance whether DL and/or UL transmission is allowed within the BAT duration. Even when DL and/or UL transmission is allowed within the BAT duration, the base station 1210 may perform scheduling such that DL transmission is not performed, or UL transmission is not allowed within the BAT duration, if necessary.

Based on the above-described assumption, the overall operation of the present disclosure is described below.

Referring first to FIG. 12A, in step S1200, the base station 1210 may determine TCI state types of the TRPs 1221, . . . , and 1222. In this case, the determination of the TCI state type may be performed per TRP as described in Section 1.1 of the first exemplary embodiment above, per TRP group as described in Section 1.2, or in the bitwise form as described in Section 1.3. The TCI state type may be the joint DL/UL TCI state type or the separate DL/UL TCI state type as described above.

In step S1205, the base station 1210 may transmit information on the determined TCI state types of the TRPs 1221, . . . , and 1222. In this case, if the TCI state type is determined for each individual TRP, information on the TCI state type may be configured and transmitted to each TRP as described in Section 1.1. As another example, if the TCI state type is configured for each TRP group, information on the TCI state type may be configured and transmitted to each TRP group as described in Section 1.2. In addition, if the TCI state types are preconfigured to be informed in a bitwise form, the information on the TCI state types may be configured and transmitted in the same manner as described in Section 1.3 above. Therefore, each of the TRPs 1221, . . . , and 1222 may receive information on the TCI state type from the base station 1210. Meanwhile, since the specific method of transmitting the TCI state type information and its variants have already been described above, further redundant description is omitted.

In steps S1210a and S1210b, each of the TRPs 1221, . . . , and 1222 may configure its own TCI state type based on the received TCI state type information.

In step S1215, each of the TRPs 1221, . . . , and 1222 may transmit the TCI state type information to the UE 1230 communicating with itself based on the configured TCI state type. Therefore, the UE 1230 may receive, from each of the TRPs, information on the TCI state type of each TRP.

In step S1220, the UE 1230 may determine the TCI state type of the TRP based on the TCI state type information received in step S1215. In addition, the UE 1230 may form a transmission beam and/or a reception beam based on the TCI state type with each TRP.

In step S1225, the UE 1230 may perform communication with the plurality of TRPs 1221, . . . , and 1222 based on the TCI state types. In other words, the UE 1230 may transmit or receive a channel or signal to or from each of the TRPs 1221, . . . , and 1222 through the transmission beam and/or the reception beam formed based on the TCI state type.

In step S1230, the base station 1210 may determine to update the TCI state type of the first TRP 1221. The update of the TCI state type may be performed for various reasons, but the present disclosure does not impose any limitation thereon.

Meanwhile, in the examples of FIG. 12A and FIG. 12B, for convenience of description, a case in which the TCI state type of the first TRP 1221 is updated is assumed and described. However, a case in which the TCI state type of another TRP is updated may also be equally applied based on the TCI state type update of the first TRP 1221 described below. In addition, in the exemplary embodiments of FIG. 12A and FIG. 12B, for convenience of description, the update of the TCI state type for one TRP is described as an example. However, as described above, even when the TCI state type is updated for a TRP group or for a plurality of TRPs (e.g. multiple TRPs not belonging to a single group), the TCI state type update may be performed based on the same manner as described below.

Referring to FIG. 12B, in step S1235, the base station 1210 may determine whether an overlapping BAT duration (i.e. an overlapping duration between a duration defined by a BAT and a physical channel) occurs, based on information received in advance from the UE 1230 as a UE capability. The occurrence of the overlapping BAT duration may correspond to a case where uplink scheduling is performed within the BAT duration required for beam switching between the first TRP 1221 and the UE 1230, or a case where periodic information such as CSI-RS is transmitted within the BAT duration. When such an overlap occurs, the base station 1210 may determine a transmission (or reception) scheme for the overlapping duration within the BAT duration. Depending on whether the BAT duration and the physical channel are fully overlapped, as described in Section 2.1 of the second exemplary embodiment above, or whether the BAT duration and the physical channel are partially overlapped, as described in Section 2.2 of the second exemplary embodiment, the transmission scheme may be determined in the same of similar manner. Alternatively, it may also be determined based on the method described in Section 2.1 above. Further, it should be noted that, as described above, when it is predetermined by the technical specifications that UL and/or DL transmission is prohibited within the BAT duration, there is no need to determine the transmission scheme for the overlapping BAT duration. Accordingly, the following operations are described excluding the prohibition based on the technical specifications. However, even in the case of prohibition based on the technical specifications, some of the following operations may still be performed. Since a person skilled in the art may selectively adopt such cases as necessary, specific examples are omitted.

In step S1240a, the base station 1210 may transmit TCI state change indication information and the corresponding transmission scheme information for the overlapping BAT duration to the first TRP 1221. In addition, in step S1240b, the first TRP 1221 or the base station 1210 may transmit the TCI state change indication information and the corresponding transmission scheme information for the overlapping BAT duration to the UE 1230. Accordingly, the first TRP 1221 and the UE 1230 may each obtain the TCI state change indication information and the information on the transmission scheme for the overlapping BAT duration.

In step S1245, the UE 1230 may change a beam with the first TRP 1221 based on the TCI state change indication information. Accordingly, the transmission beam and/or the reception beam may be changed during the BAT duration.

In step S1250, the UE 1230 may perform transmission of a UL channel and/or reception of a DL channel based on the information on the transmission scheme for the overlapping BAT duration received from the base station 1210 or the first TRP 1221. Step S1250 is indicated with a dashed line because transmission of a UL channel and/or reception of a DL channel within the overlapping BAT duration may not be performed depending on the capability of the UE 1230 and a decision of the base station 1210.

After the BAT duration ends, in step S1255, the UE 1230 may perform communication with the first TRP 1221 and the N-th TRP 1222 based on the configured TCI states. After the BAT duration ends, in step S1255, the UE 1230 may perform communication with the first TRP 1221 and the N-th TRP 1222 based on the configured TCI states.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
communicating with a first transmission and reception point (TRP) using a first beam based on a configured transmission configuration indicator (TCI) state type;
receiving a TCI state change indication for the first TRP;
configuring, during a beam application time (BAT), a second beam for communicating with the first TRP based on the received TCI state change indication; and
in response to transmission of first information in uplink (UL) being required, transmitting the first information to the first TRP in the uplink using the second beam,
wherein a time for transmitting the first information in the UL is determined as a time after a sum of a first time value based on a processing capability of the UE and the BAT value.

2. The method according to claim 1, wherein the first time value is determined as a sum of a margin value and a first processing time value calculated based on a duration of symbols received from the first TRP through a physical downlink shared channel (PDSCH).

3. The method according to claim 1, further comprising:
receiving first indication information indicating whether to allow transmission of information to the first TRP in the UL within the BAT time duration; and
in response to the first indication information indicating that the transmission of the information in the UL is allowed and presence of second information to be transmitted within the BAT time duration, transmitting the second information to the first TRP using the first beam.

4. The method according to claim 3, wherein the time for transmitting the first information is determined as a time after the first time value.

5. The method according to claim 1, further comprising:
receiving second indication information indicating whether to allow reception of information from the first TRP in a downlink (DL) within the BAT time duration; and
in response to the second indication information indicating that the transmission of the information in the DL is not allowed, stopping a DL reception operation within the BAT time duration.

6. The method according to claim 1, further comprising:
receiving second indication information indicating whether to allow reception of information from the first TRP in the DL within the BAT time duration; and
in response to the second indication information indicating that transmission of information in the DL is allowed and presence of third information scheduled to be received in the DL within the BAT time duration, receiving the third information from the first TRP using the first beam.

7. A user equipment (UE), comprising: at least one processor, wherein the at least one processor causes the UE to perform:
communicating with a first transmission and reception point (TRP) using a first beam based on a configured transmission configuration indicator (TCI) state type;
receiving a TCI state change indication for the first TRP;
configuring, during a beam application time (BAT), a second beam for communicating with the first TRP based on the received TCI state change indication; and
in response to transmission of first information in uplink (UL) being required, transmitting the first information to the first TRP in the uplink using the second beam,
wherein a time for transmitting the first information in the UL is determined as a time after a sum of a first time value based on a processing capability of the UE and the BAT value.

8. The UE according to claim 7, wherein the first time value is determined as a sum of a margin value and a first processing time value calculated based on a duration of symbols received from the first TRP through a physical downlink shared channel (PDSCH).

9. The UE according to claim 7, wherein the at least one processor further causes the UE to perform:
receiving first indication information indicating whether to allow transmission of information to the first TRP in the UL within the BAT time duration; and
in response to the first indication information indicating that the transmission of the information in the UL is allowed and presence of second information to be transmitted within the BAT time duration, transmitting the second information to the first TRP using the first beam.

10. The UE according to claim 9, wherein the time for transmitting the first information is determined as a time after the first time value.

11. The UE according to claim 7, wherein the at least one processor further causes the UE to perform:
receiving second indication information indicating whether to allow reception of information from the first TRP in a downlink (DL) within the BAT time duration; and
in response to the second indication information indicating that the transmission of the information in the DL is not allowed, stopping a DL reception operation within the BAT time duration.

12. The UE according to claim 7, wherein the at least one processor further causes the UE to perform:
receiving second indication information indicating whether to allow reception of information from the first TRP in the DL within the BAT time duration; and
in response to the second indication information indicating that transmission of information in the DL is allowed and presence of third information scheduled to be received in the DL within the BAT time duration, receiving the third information from the first TRP using the first beam.

13. A method of a base station, comprising:
determining a transmission configuration indicator (TCI) state type of each of transmission and reception points (TRPs) connected to the base station;
transmitting, to the TRPs, information on TCI state types of the TRPs;
in response to a change in a TCI state type of a first TRP among the TRPs being required, transmitting TCI state type update information to the first TRP;
determining a transmission scheme of an uplink (UL) channel or a downlink (DL) channel within a first time duration that at least partially overlaps with a beam application time (BAT) duration of a user equipment (UE) communicating with the first TRP; and
transmitting information on the transmission scheme of the UL channel or the DL channel to the first TRP and the UE.

14. The method according to claim 13, wherein the information on the TCI state types is configured by individually mapping information capable of identifying each of the TRPs and a corresponding TCI state type.

15. The method according to claim 14, wherein the information capable of identifying each of the TRPs includes at least one of a TRP identifier (ID), a control resource set (CORESET) identifier (ID), a CORESET group ID, or a search space ID.

16. The method according to claim 13, wherein the TCI state types are respectively configured for preconfigured TRP groups, and information on the TRP groups is transmitted to the TRPs through higher layer signaling.

17. The method according to claim 16, wherein when a change in the TCI state type of the first TRP among the TRPs is required and a change in a TCI state type of a second TRP belonging to a same TRP group as the first TRP is required, transmission of information indicating an update of the TCI state type of the second TRP is omitted.

18. The method according to claim 13, wherein the information on the TCI state types is configured by concatenating one-bit values respectively indicating TCI state types of the TRPs, based on a descending or ascending order of TRP indexes corresponding to the TRPs.

19. The method according to claim 13, wherein the transmission scheme of the UL channel or the DL channel within the first time duration is configured based on a TCI state type before a TCI state update.

20. The method according to claim 13, wherein the transmission scheme is configured to prohibit transmission of the UL channel or the DL channel within the first time duration, and the transmission scheme is determined based on UE capability information reported in advance from the UE.
